(19) United States
(12) Patent Application Publication
(10) Pub. No.: US 2007/0054071 A1
(43) Pub. Date: Mar. 8, 2007

(54) Packaging container with a laminate and process for manufacturing the laminate

(76) Inventor: Hans-Rudolf Nageli, Neuhausen (CH)

Correspondence Address: FISHER, CHRISTEN & SABOL, 1725 K STREET, N.W., SUITE 1108, WASHINGTON, DC, 20006, US

(21) Appl. No.: 11/511,414

(22) Filed: Aug. 29, 2006

(30) Foreign Application Priority Data
Sep. 7, 2005 (EP) 05405527.2

(51) Int. Cl. B32B 27/10

(52) U.S. Cl. 428/34.2; 428/35.2

(57) ABSTRACT

A packaging container is such that a laminate (45) features a film-shaped substrate (44) bonded to a hot-sealing layer (38) via a contact adhesive layer (36)—for easy opening and re-closing the container—arranged between an adhesive layer (34) of permanent adhesive and a hot-sealing layer (38) and is bonded to itself via a sealing seam or to another film to form a pouch or, as lid, bonded to the edge of a pouch.

For the production of the laminate (48), the film-type substrate (44) is coated—via liquid-film coating using the curtain coating or slide-coating method—with a multi-layer liquid film comprising at least an adhesive layer (34), the contact adhesive layer (36) and the cohesively rupturing hot-sealing layer (36).

The invention relates to a packaging container with a laminate which comprises a foil-shaped substrate bonded via a contact adhesive layer to a hot-sealing layer for easy opening and re-closing the container, and is joined via a sealing seam to itself or to another film forming a pouch or, as a lid, joined to the edge of a container. Also within the scope of the invention is a process for manufacturing the laminate for the packaging container.

A re-closable container is known e.g. from EP-A-0 957 045. For decades now, a liquid-film coating process known as “curtain coating” has been used for manufacturing multi-layer photographic films and papers. In that coating process several layers are deposited simultaneously in the form of a free-falling curtain onto a moving strip of material. It has also been proposed to use curtain coating technology for coating papers and for manufacturing plastic laminate materials.

In WO-A-0154828 a process for manufacturing a multi-layer packaging laminate with at least two superimposed layers is made known, in which process two or more layers are deposited in liquid form onto a substrate made of paper, cardboard or plastic film—which may if desired already be coated—then subsequently dried. The liquid film coatings are adhesive layers, barrier layers, intermediate layers acting as spacers, oxygen-scavenger layers and hot-sealing layers.

Known from U.S. Pat. No. 6,845,599 is a liquid coating process which is an alternative to curtain coating and is known by the name “slide coating”. In that coating process several layers are applied simultaneously from a nozzle slide surface directly onto a substrate which is passed directly over a run-off edge of the nozzle.

The object of the invention is to develop a packaging material of the kind described at the start which enables the production of re-closable forms of packaging in a simple and cost-favourable manner. With respect to the packaging container that objective is achieved by way of the invention in that the contact adhesive layer is provided between an adhesive layer of permanent adhesive and the hot-sealing layer or between two adhesive layers of permanent adhesive and the hot-sealing layer fractures in a cohesive manner.

With respect to the process the object of the invention is achieved by way of the invention in that, using the curtain coating or slide coating method, the film-type substrate is coated via liquid-film coating with a multi-layer liquid film comprising at least an adhesive layer, the contact adhesive layer, and a hot-sealing layer that fractures in a cohesive manner, or the film-type substrate or a cohesive rupturing hot-sealing layer is coated via liquid-film coating using the curtain coating or slide coating method with a multi-layer liquid film comprising at least two adhesive layers and the contact adhesive layer, whereby the contact adhesive layer is situated between the adhesive layers, and the substrate—coated with the multi-layer liquid film—or the coated cohesive rupturing hot-sealing layer is subsequently bonded to a cohesive rupturing hot-sealing film or to the substrate.

The term “contact adhesive” is also known in English as “pressure sensitive adhesive (PSA). A connection made using a contact adhesive layer can be repeatedly interrupted and re-made.

The thickness of the layers of adhesive is usefully about 1 to 30%, preferably 1 to 10%, of the thickness of the contact adhesive layer.

The layer of contact adhesive may e.g. be made up of an acrylic-based adhesive. Other suitable basic substances are A-B-A block-copolymers of isoprene and styrene or butadiene and styrene. The adhesive layers may e.g. be composed of urethane-based adhesives for example polyether, polyester or polybutadiene polyols, acrylic or epoxy based or of combinations of the adhesives mentioned. The layers of liquid film may be solvent-based, solvent-free or water-based. Solvent-free coating fluids are preferred, as they do not require the usual drying step. Substrates that may be employed are plastic films e.g. polyethylene-terephthalate (PET), polyethylene (PE), polypropylene (PP), polyamide (PA), metal foils such as e.g. aluminium foils, if desired coated with a barrier material e.g. of SiOₓ, paper or a combination of at least two of the aforementioned materials.

Further advantages, features and details of the invention are revealed in the following description of preferred exemplified embodiments and with the aid of the drawing which shows schematically in:

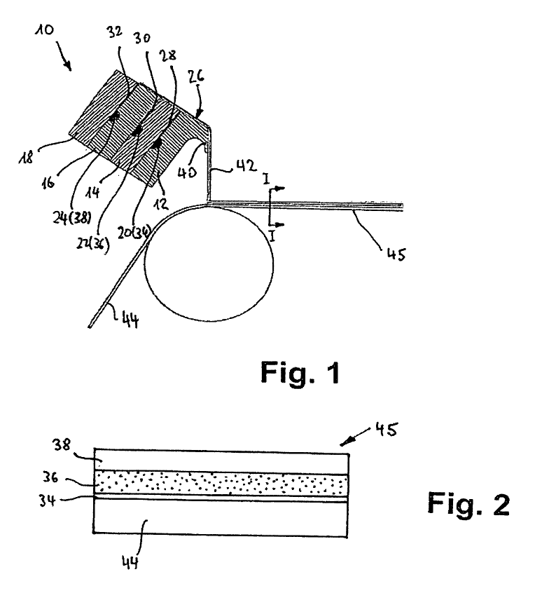

FIG. 1 the sequence in the process of coating a substrate using curtain coating, shown in cross-section:

FIG. 2 a cross-section through a detail in FIG. 1 along line I-I;

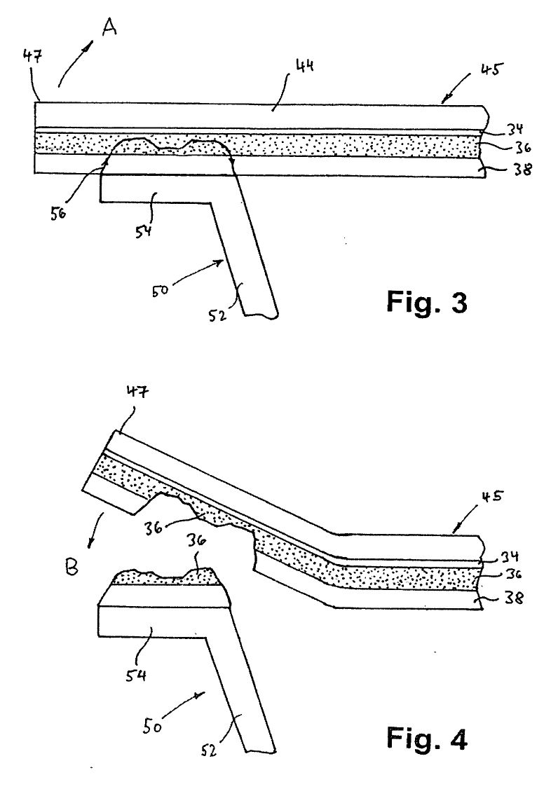

FIG. 3 a cross-section through a part of a container closed with a sealed-on laminate in FIG. 1;

FIG. 4 the cross-section in FIG. 3 with partially opened container;

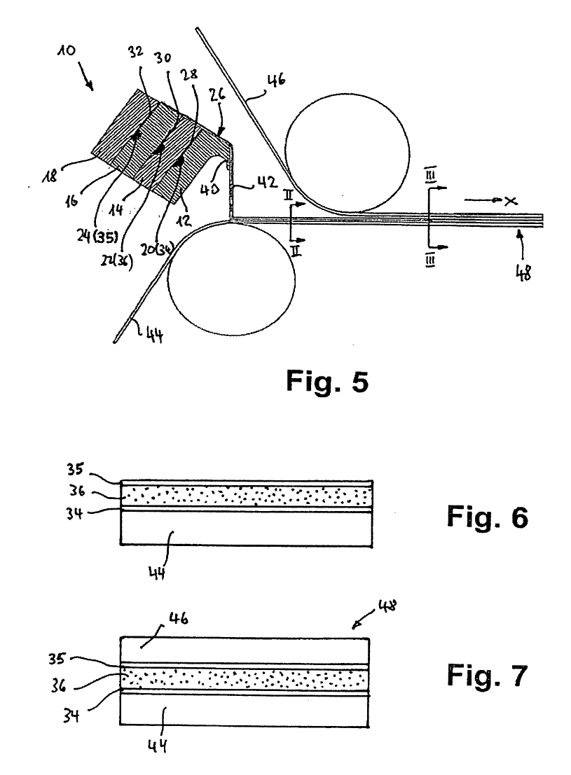

FIG. 5 the sequence in the process for joining two substrates using curtain coating, shown in cross-section;

FIG. 6 a cross-section through a detail in FIG. 5 along line II-II;

FIG. 7 a cross-section through a detail in FIG. 5 along line III-III;

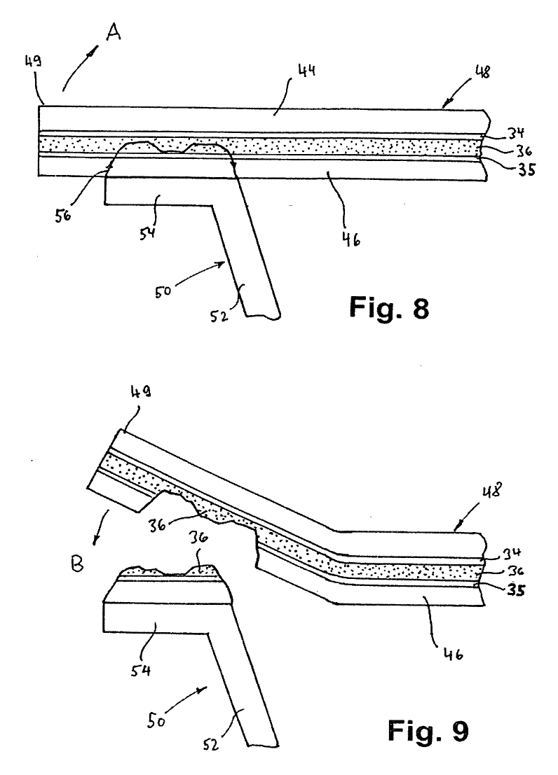

FIG. 8 a cross-section through a part of a container sealed using the laminate in FIG. 5;

FIG. 9 the cross-section in FIG. 4 with partially opened container;

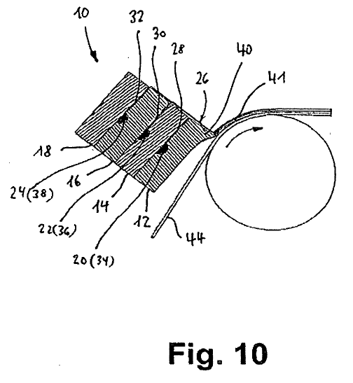

FIG. 10 the slide-coating process, as alternative to curtain coating, shown in cross-section.

Shown in FIG. 1 is a nozzle arrangement 10 in a slide-surface-coating device for liquid-film coating using the curtain coating method which exhibits a series of four modules 12, 14, 16, 18 situated one on top of the other. Together the series of modules 12, 14, 16, 18 form three distribution chambers 20, 22, 24—arranged transverse to a direction of strip movement x—each having an outlet slit 12, 14, 16, 18 ending at a nozzle slide surface 26. The distribution chambers 20, 22, 24 are supplied with coating fluids 34 (permanent adhesive), 36 (contact adhesive), 38 (sealing lacquer) separately and in dosed amounts corresponding to the amount required at the nozzle slide surface 26.

The coating fluids 34, 36, 38, arriving at the nozzle slide surface 26 via the outlet slits 28, 30, 32, and running in layers of superimposed coating fluids 34, 36, 38 as a three-layer liquid film over a run-off edge 40 on module 12, form a free-falling curtain 42.

The free-falling curtain 42 of coating fluids 34, 36, 38 meets, essentially perpendicular, a substrate strip 44 moving in direction x, and forms on its surface the fluid coating shown in FIG. 2 as part of a laminate 45. Shown in FIG. 3 is a laminate 45 in the form of a lid with tear-off flap 47 sealed onto a sealing edge 54 projecting out from a wall 52 of a container 50. On pulling the tear-off flap 47 in direction A the cohesive rupturing hot-sealing layer 38 tears at the outer edge of the sealing edge 54 and a crack 56 is propagated into the contact adhesive layer 36 and continues inwards in or at the edge of the contact adhesive layer 36. At the inner edge of the sealing edge 54 the hot-sealing layer is again torn through. On further pulling on the tear-off flap 47 in direction A the lid or the laminate 45 is separated from the sealing edge 54 and the container 50 is opened. As shown in FIG. 4 the crack 56 formed by pulling on the tear-off flap leads to the contact adhesive layer 36 being exposed in the region of the sealing edge 54 whereby, depending on how the crack runs, the contact adhesive layer 36 on the substrate 44 and/or the hot-sealing layer 38 remains in place. By pressing the lid or the laminate 45 in the direction B towards the sealing edge 54 the lid again sticks to the sealing edge 54 of the container 50. This way the container 50 can be repeatedly opened and closed again.

The container shown in FIGS. 3 and 4 with pull-off lid is made up as follows:

| | |
|---|---|
| Substrate 44 | polyethylene-terephthalate (PET) film |
| Adhesive layer 34 | polyurethane (PUR) |
| Contact adhesive layer 36 | acrylic-based |
| Hot sealing lacquer 38 | acrylic-based |
| Container 50 | polypropylene (PP) |

A nozzle arrangement 10 shown in FIG. 5 of a slide-surface coating device for liquid-film coating using the curtain-coating method exhibits, as in the arrangement in FIG. 1, a series of four modules 12, 14, 16, 18 mounted one on top of the other. The modules 12, 14, 16, 18 together form three distribution chambers 20, 22, 24 arranged transverse to the direction of strip movement x, each featuring an outlet slit 28, 30, 32 ending at a nozzle slide surface 26. The distribution chambers 20, 22, 24 are supplied with coating fluids 34 (permanent adhesive), 36 (contact adhesive), 35 (permanent adhesive) separately and in dosed amounts corresponding to the amount required at the nozzle slide surface 26. The coating fluids 34, 36, 35, running out of the distribution chambers 20, 22, 24 via the outlet slits 28, 30, 32 at the nozzle slide surface 26, run as a three-layer superimposed coating film over a run-off edge 40 on module 12 and form a free-falling curtain 42.

The free-falling three layer curtain 42 of coating fluids 34, 36, 35 meets, essentially perpendicular, a substrate strip 44 moving in direction x, and forms the fluid coating shown in FIG. 6 on its surface.

Moving in direction x the first substrate strip 44 coated with coating fluids 34, 36, 35 meets a second substrate strip 46 in the form of a hot-sealing film and is adhesively bonded to it forming a laminate as shown in FIG. 7. Instead of a hot-sealing film as second substrate strip 46, it is possible e.g. to deposit a hot-sealing layer on the first substrate layer 44 coated with coating fluids 34, 36, 35 by means of extrusion coating.

Shown in FIG. 8 is a laminate 48 sealed as a lid with tear-off flap 49 on a sealing edge 54 projecting out from the wall 52 of a container 50. On pulling the tear-off flap 49 in the direction of the arrow A the cohesive rupturing hot-sealing layer 46 tears at the outer edge of the sealing edge 54 and a crack 56 is propagated into contact adhesive layer 36 and runs inwards, in or at the edge of the contact adhesive layer 36. At the inner edge of the sealing edge 54 the hot sealing layer 46 ruptures again. On pulling the tear-off flap 49 further in direction A the lid or the laminate 48 is separated from the sealing edge 54 and the container 50 is opened. As shown in FIG. 9 the crack 56 formed by pulling on the tear-off flap 49 leads to the contact adhesive layer 36 being exposed in the region of the sealing edge 54 whereby, depending on the path taken by the crack, the contact adhesive layer 36 on the substrate 44 and/or the hot-sealing layer 46 remains in place. By pressing the lid or the laminate 48 in the direction of the arrow B against the sealing edge the lid again adheres to the sealing edge 54 of the container 50. This way it is possible to repeatedly open and re-close the container 50.

The container 50 with tear-off lid shown in FIGS. 8 and 9 is made up e.g. as follows:

| | |
|---|---|
| Substrate 44 | polyethylene-terephthalate (PET) film |
| Adhesive layer 34 | polyurethane (PUR) |
| Contact adhesive layer 36 | acrylic-based |
| Adhesive layer 35 | polyurethane (PUR) |
| Hot-sealing layer 46 | polypropylene (PP) |
| Container 50 | polypropylene (PP) |

FIG. 10 shows a nozzle arrangement 10 with essentially the same arrangement as the nozzle arrangement in FIG. 1, whereby the run-off edge 40 has been adapted to suit the slide-coating process. Here, the three-layer liquid film 41 slides from the run-off edge 40 directly onto the substrate strip 44 which is led past the run-off edge 40.

1: A packaging container with a laminate (48, 45), comprising a film-shaped substrate (44) bonded to a hot-sealing layer (38, 46) via a contact adhesive layer (36) for easy opening and re-closing the container, and is bonded to itself via a sealing seam or to another film to form a pouch or, as a lid, bonded to the edge of a pouch, the contact adhesive layer (36)
(a) is arranged between a layer of adhesive (34) in the form of permanent adhesive and the hot-sealing layer (38), or
(b) between two layers of adhesive (34, 35) in the form of permanent adhesive,
and the hot-sealing layer (38, 46) ruptures in a cohesive manner.

2: The packaging container according to claim 1, wherein the adhesive layers (34, 35) are functionally optimized with respect to the neighboring substrate (44) and the hot-sealing layer (46).

3: The packaging container according to claim 2, wherein the thickness of the adhesive layer (34, 35) is smaller than the thickness of the contact adhesive layer (36).

4: The packaging container according to claim 3, wherein the thickness of the adhesive layers (34, 35) is 1 to 30 percent, of the thickness of the contact adhesive layer (36).

5: The packaging container according to claim 4, wherein the adhesive layers (34, 35) are composed of adhesives that are urethane-based.

6: The packaging container according to claim 5, wherein the contact adhesive layer (36) contains an adhesive based on acrylic or A-B-A block-copolymers of isoprene and styrene or butadiene and styrene.

7: The packaging container according to claim 6, wherein the layers (34, 36, 38; 34, 36, 35) of liquid film are solvent-based, solvent-free or water-based.

8: The packaging container according to claim 7, wherein the substrate (44) is a plastic film, a metal foil, paper or a combination of at least two of the mentioned materials.

9: A process for manufacturing a laminate (45, 48), comprising bonding a film-shaped substrate (44) via a contact adhesive layer (36) to a hot-sealing layer (38, 46) for easy opening and reclosing a packaging container, and joining the film-shaped substrate (44) having the hot-sealing layer (38, 46) via a sealing seam to itself or to another film allowing it to be formed into a pouch or a lid joined to the edge of a container,
(a) coating utilizing curtain coating or slide coating method, the film-shaped substrate (44) is coated via liquid-film coating with a multi-layer liquid film comprising at least an adhesive layer (34), the contact adhesive layer (36), and the hot-sealing layer (38) that fractures in a cohesive manner, or the film-shaped substrate, or
(b) coating the film-shaped substrate (44) or the cohesively rupturing hot-sealing layer (46) via liquid-film coating utilizing the curtain coating or slide coating method with a multi-layer liquid film comprising at least two adhesive layers (34, 35) and the contact adhesive layer (36), whereby the contact adhesive layer (36) is situated between the adhesive layers (34, 35), and subsequently bonding the film shaped substrate (44) coated with the multi-layer liquid film or the coated cohesive rupturing layer hot-sealing layer (46) is to a cohesive rupturing hot-sealing film (46) or to the film-shaped substrate (44).

10: The process according to claim 9, wherein the adhesive layers (34, 35) are functionally optimized with regard to the surface of the bordering substrate (44) and the hot-sealing layer (46).

11: The process according to claim 10, wherein the thickness of the adhesive layers (34, 35) is smaller than the thickness of the contact adhesive layer (36).

12: The process according to claim 11, wherein the thickness of the adhesive layers (34, 35) is 1 to 30 percent of the thickness of the contact adhesive layer (36).

13: The process according to claim 12, wherein the adhesive layers (34, 35) are composed of urethane-based or acrylic-based adhesives.

14: The process according to claim 13, wherein the contact adhesive layer (36) contains an adhesive on the basis of acrylic, A-B-A block copolymers of isoprene and styrene or butadiene and styrene.

15: The process according to claim 14, wherein the layers (34, 36, 38; 34, 36, 35) of liquid film are solvent-based, solvent-free or water-based.

16: The process according to claim 15, wherein the substrate (44) is a plastic film, a metal foil, paper or a combination of at least two of the mentioned materials.

17: A laminate manufactured utilizing the process according to claim 16.

18: The packaging container according to claim 1, wherein thickness of the adhesive layer (34, 35) is smaller than the thickness of contact adhesive layer (36).

19: The packaging container according to claim 18, wherein the thickness of the adhesive layers (34, 35) is 1 to 30 percent of the thickness of the contact adhesive layer (36).

20: The packaging container according to claim 18, wherein the thickness of the adhesive layers (34, 35) is 1 to 10 percent of the thickness of the contact adhesive layer (36).

21: The packaging container according to claim 3, wherein the thickness of the adhesive layers (34, 35) is 1 to 10 percent of the thickness of the contact adhesive layer (36).

22: The packaging container according to claim 5, wherein the adhesive layers (34, 35) are composed of adhesive that are urethane-based selected from the group consisting of polyethers, polyesters or polybutadiene polyols acrylic or epoxy based or of combinations of the mentioned adhesives.

23: The packaging container according to claim 1, wherein the adhesive layers (34, 35) are composed of adhesives that are urethane-based.

24: The packaging container according to claim 1, wherein the adhesive layers (34, 35) are composed of adhesives that are urethane-based selected from the group consisting of polyethers, polyesters or polybutadiene polyols acrylic or epoxy based or of combinations of the mentioned adhesives.

25: The packaging container according to claim 1, wherein the contact adhesive layer (36) contains an adhesive based on acrylic or A-B-A block-copolymers of isoprene and styrene or butadiene and styrene.

26: The packaging container according to claim 1, wherein the layers (34, 36, 38; 34, 36, 35) of liquid films are solvent-based, solvent-free or water-based.

27: The packaging container according to claim 1, wherein the substrate (44) is a plastic film, a metal foil, paper or a combination of at least two of the mentioned materials.

28: The process according to claim 9, wherein thickness of the adhesive layers (34, 35) is smaller than thickness of the contact adhesive layer (36).

29: The process according to claim 28, wherein the thickness of the adhesive layers (34, 35) is 1 to 30 percent of the thickness of the contact adhesive layer (36).

30: The process according to claim 29, wherein the thickness of the adhesive layers (34, 35) is 1 to 10 percent of the thickness of the contact adhesive layer (36).

31: The process according to claim 10, wherein the thickness of the adhesive layers (34, 35) is 1 to 10 percent of the thickness of the contact adhesive layer (36).

32: The process according to claim 9, wherein the thickness of the adhesive layers (34, 35) is smaller than the thickness of the contact adhesive layer (36).

33: The process according to claim 9, wherein the adhesive layers (34, 35) are composed of urethane-based or acrylic-based adhesives.

34: The process according to claim 9, wherein the contact adhesive layer (36) contains an adhesive on the basis of acrylic. A-B-A block copolymers of isoprene and styrene or butadiene and styrene.

35: The process according to claim 9, wherein the layers (34, 36, 38; 34, 36, 35) of liquid film are solvent-based, solvent-free or water based.

36: The process according to claim 9, wherein the substrate (44) is a plastic film, a metal foil, paper or a combination of at least two of the mentioned materials.

37: A laminate manufactured utilizing the process according to claim 9.
